(19) United States
(12) Patent Application Publication
(10) Pub. No.: US 2015/0090155 A1
(43) Pub. Date: Apr. 2, 2015

(54) INKJET INK COMPOSITION

(71) Applicant: Domino Printing Sciences PLC, Cambridge (GB)

(72) Inventors: Julie Cross, Watford (GB); Andrew Noble, Cambridge (GB)

(21) Appl. No.: 14/398,549

(22) PCT Filed: Apr. 29, 2013
(86) PCT No.: PCT/GB2013/051095

§ 371 Date: Nov. 3, 2014

(30) Foreign Application Priority Data
May 3, 2012 (GB) 1207803.6

(51) Int. Cl. C09D 11/38

(52) U.S. Cl. CPC C09D 11/38
USPC 106/31.13

(57) ABSTRACT

The present invention relates to an inkjet ink composition comprising: a colourant; a carrier; and a saccharide additive comprising: (a) a monosaccharide and/or derivative thereof; and/or (b) a disaccharide and/or derivative thereof; and/or (c) a tri- or polysaccharide and/or derivative thereof.

The present invention relates to an inkjet ink composition comprising a saccharide additive and the use of such a composition in an inkjet printing method. The present invention also relates to use of a saccharide additive as a nozzle plate wetting reducing additive, and/or as a throw distance increasing additive, and/or as a decap time increasing additive in an ink composition. The present invention also relates to a method of reducing the nozzle plate wetting of an ink composition, to a method of increasing throw distance of an ink composition, and to a method of increasing decap time of an ink composition,

In the field of industrial coding and marking, codes, dating, and traceability information are applied directly onto products and/or product packaging. To achieve high quality images, the inkjet ink must not create a puddle on the nozzle plate through excessive nozzle plate wetting. In addition it is advantageous for an ink composition to have a long decap time so that substantially perfect codes can be printed after periods of inactivity, and/or so that the quality of the printed image recovers quickly. To be capable of printing onto a wide range of substrates which can come in a wide variety of forms e.g. curved, serrated, or lipped it is also important that the ink composition can also provide a long enough throw distance to be capable of printing a high quality image with a gap between the coding equipment print head and substrate that is large enough to accommodate the range of forms that might be encountered in an industrial environment.

Nozzle plate wetting occurs when not all of the ejected ink reaches the substrate but instead small amounts of the ejected drops are left behind and collect on the nozzle plate or around the edges of the nozzles. This occurs when ink drops exiting the orifices leave behind minute amounts of ink on the orifice plate around each orifice. The extent of the nozzle plate wetting varies from a few, small drops of ink to the formation of large puddles on large portions of the orifice plate. Large puddles partially or completely block the orifices and cause missing nozzles, false low decap values, or changes in the trajectory of the ink drops, all of which can lead to a reduction in print quality. The change in trajectory results in the ink drop not hitting its targeted pixel center, which creates printing errors on the media and reduces the quality of the printed image.

Some inkjet inks suffer from the ink drying out around the nozzles resulting in poor decap behaviour. Decap time is the period of time that a printhead can be left uncapped and idle and still produce a high quality code when printing is restarted. Loss of print quality can in many cases be recovered by wiping the nozzles or repeated firing. If this recovery is not achievable, the image quality will continue to deteriorate. Poor decap performance is often caused by the solvent in the ink evaporating and leaving behind non-volatile materials which are detrimental to jetting performance. A common method of improving the decap performance of an inkjet ink is to add non-volatile humectants to the ink to reduce the likelihood of the ink drying in the nozzles. However this can have a detrimental effect on the drying time of the ink. It is therefore important to identify a method of extending the decap time or achieving rapid recovery of the print quality without the need to use high levels of non-volatile humectants.

Industrial coding also requires reliable non-contact coding technology that is able to mark a wide range of substrates, which can come in a variety of forms e.g. curved, serrated, or lipped. The most versatile coding technologies are able to print with a gap between the coding equipment print head and substrate that is large enough to accommodate the range of forms that might be encountered in an industrial environment. This gap is termed throw distance.

Thermal inkjet (TIJ) printing is a desirable coding and marking technology as it offers significantly higher print resolutions than competing technologies in the field, such as continuous inkjet, but has had limited acceptance because of poor throw distance, and relatively poor reliability. Typically a continuous inkjet printer will operate at a throw distance in the range 5-12 mm, whereas presently available TIJ printing systems are limited to throw distances of the order of 1 mm.

The use of additives to control nozzle plate wetting is described in US patent application US2004/0055507. The nozzle plate wetting additive comprises an anionic polar group and a C₆-C₃₀ hydrocarbon chain. An inkjet ink comprising a dye, an inkjet vehicle and the nozzle plate wetting additive are described. Nozzle plate wetting control is also the topic of International (PCT) patent application WO2007/044110 where an inkjet ink comprising a colorant, an inkjet vehicle and an additive formed from at least a polymeric material having at least one polar group and having at least one pendant group comprising an R_{f} group, where the polymeric material has at least 2 repeat units is described.

International (PCT) patent application WO2011/041364 describes a thermal inkjet ink composition comprising a volatile organic solvent, a binder resin, a dye, a humectant and an additive for extending the decap time. The additive is selected from the group consisting of plasticisers, surfactants, aliphatic hydrocarbons, drying oils and mixtures thereof. A further International (PCT) Patent Application WO2010/042105 discloses the use of a decap controlling additive which has a vapour pressure from 1-5 mm Hg at 25° C. and has a boiling point greater than the base solvent of the ink and is selected from the group consisting of 1-methoxy-2-propanol, ethyl lactate, tert-butanol, tert-butyl acetate, 1-butanol and combinations thereof.

International (PCT) patent application WO9842517 describes a method of increasing throw distance in an inkjet printer. A drive arrangement for a piezoelectric inkjet print head is described which includes a double peak waveform. This is said to cause the droplet tail to break off early following ejection resulting in enhanced flight characteristics and increased throw distance.

It would be desirable to provide an improved inkjet ink composition. In particular it would be desirable to reduce the nozzle plate wetting of an ink composition, to increase the throw distance of an ink composition, and/or to increase the decap time of an ink composition. It would be advantageous if this could be achieved using additives that are effective in relatively low amounts and/or that do not substantially negatively affect other properties of the inkjet inks. In addition, it would be desirable to use additives that are effective in many types of ink vehicles.

It is one object of the present invention to overcome or address the problems of prior art inkjet ink compositions or to at least provide a commercially useful alternative thereto. It is an alternative and/or additional object to provide an inkjet ink composition which is cheaper to make and/or more effective than known inkjet compositions and/or which preferably has reduced nozzle plate wetting and/or increased throw distance and/or increased decap time than known inkjet compositions.

In the first aspect of the present invention there is provided an inkjet ink composition comprising:
a colourant;
a carrier; and
a saccharide additive comprising:
   (a) a monosaccharide and/or derivative thereof; and/or
   (b) a disaccharide and/or derivative thereof; and/or
   (c) a tri- or polysaccharide and/or derivative thereof.

The present invention will now be further described. In the following passages different aspects of the invention are defined in more detail. Each aspect so defined may be combined with any other aspect or aspects unless clearly indicated to the contrary. In particular any feature indicated as being preferred or advantageous may be combined with any other feature or features indicated as being preferred or advantageous.

In a further aspect of the present invention there is provided the use of a saccharide additive, wherein the saccharide additive comprises:
(a) a monosaccharide and/or derivative thereof; and/or
(b) a disaccharide and/or derivative thereof; and/or
(c) a tri- or polysaccharide and/or derivative thereof;
as a nozzle plate wetting reducing additive in an ink composition.

In a further aspect of the present invention there is provided the use of a saccharide additive, wherein the saccharide additive comprises:
(a) a monosaccharide and/or derivative thereof; and/or
(b) a disaccharide and/or derivative thereof; and/or
(c) a tri- or polysaccharide and/or derivative thereof;
as a throw distance increasing additive in an ink composition.

In a further aspect of the present invention there is provided the use of a saccharide additive, wherein the saccharide additive comprises:
(a) a monosaccharide and/or derivative thereof; and/or
(b) a disaccharide and/or derivative thereof; and/or
(c) a tri- or polysaccharide and/or derivative thereof;
as a decap time increasing additive in an ink composition.

In a further aspect of the present invention there is provided an inkjet printing method comprising the steps of providing an ink cartridge containing the ink composition as described herein; ejecting droplets of the ink composition and depositing the droplets onto a recording medium, for example a substrate, to perform printing.

In another aspect of the present invention there is provided a method of reducing the nozzle plate wetting of an ink composition, the method comprising adding a saccharide additive to said ink composition, wherein the saccharide additive comprises:
(a) a monosaccharide and/or derivative thereof; and/or
b) a disaccharide and/or derivative thereof; and/or
(c) a tri- or polysaccharide and/or derivative thereof.

In another aspect of the present invention there is provided a method of increasing throw distance of an ink composition, the method comprising adding a saccharide additive to said ink composition, wherein the saccharide additive comprises:
(a) a monosaccharide and/or derivative thereof; and/or
(b) a disaccharide and/or derivative thereof; and/or
(c) a tri- or polysaccharide and/or derivative thereof.

In another aspect of the present invention there is provided a method of increasing decap time of an ink composition, the method comprising adding a saccharide additive to said ink composition, wherein the saccharide additive comprises:
(a) a monosaccharide and/or derivative thereof; and/or
(b) a disaccharide and/or derivative thereof, and/or
(c) a tri- or polysaccharide and/or derivative thereof.

Nozzle plate wetting is defined as a build up of ink around the nozzles which can eventually result in a puddle of ink on the nozzle plate. Nozzle plate wetting of an inkjet composition may be assessed qualitatively through the use of camera systems focused on the nozzle plate.

As used herein the term “throw distance” is defined as the distance between the printhead and the substrate that can be used whilst still achieving the required image quality. The throw distance of an inkjet composition may be measured by printing a test pattern with increasing distances between the printhead and the substrate and assessing the quality of the printed code. This may include printing a bar code and assessing the grade of the bar code using a bar code verifier, measuring the thickness of a printed line or simply visually assessing the quality of printed text. A suitable bar code verifier which may be used for assessing the grade of a bar code is an Integra 9505 Barcode Quality Station. This equipment provides a bar code grading from A-F and ‘no valid code’ with A-C being an acceptable bar code and D, F and ‘no valid code’ being a low quality bar code.

The term “decap control,” as referred to herein, means the ability of the inkjet ink to readily eject from the print head, upon prolonged exposure to air. The ink decap time is measured as the amount of time that an inkjet printhead may be left uncapped before the printer nozzles no longer fire properly, potentially because of clogging or plugging. Generally, nozzle(s) may become clogged (i.e. impeded, slowed) or plugged (i.e. obstructed, substantially or completely closed) by a viscous plug that forms in the nozzle(s) as a result of water/solvent loss, crusting of the ink, and/or crystallization of the dye in and/or around any of the nozzles. If a nozzle has become clogged, ink droplets ejected through the nozzle's orifice may be misdirected, which may adversely affect print quality. When an orifice is plugged, it becomes substantially or completely blocked. As a result of the nozzle being plugged, the ink droplets may not pass through the affected nozzle. Thus, the criteria for measuring failure to fire by a nozzle is that there is a misdirection of ink through the nozzle's orifice to a lesser or greater degree, or a complete blockage, which can be precisely indicated in a printed image on media printed by the nozzle. The clogging and plugging effect on nozzles and their ink printing performance can be tested by various methods. In its simplest form, one method involves printing a given test pattern with the printhead nozzles to verify their working condition. This is followed by exposing the nozzles to the air for a fixed time without printing or spitting the nozzles. Then, all of the nozzles are printed again in the given test pattern for the second time. The test patterns are then compared to determine the number of weak or misdirected nozzles. In the worst case, such nozzle clogging or plugging results in a complete failure to fire by the nozzle.

The term “decap time” may be defined as the amount of time that an inkjet printhead may be left uncapped and still produce a high quality code with minimal missing nozzles when printing resumes. The decap time of an inkjet composition may be measured by printing a test pattern then leaving the printhead uncapped with the nozzles exposed to the air for predetermined increasing periods of time and printing the test pattern again. The quality of the printed code may then be assessed and the longest period of time that the printhead may be left uncapped and still produce a high quality code with minimal missing nozzles when printing resumes is taken as the decap time of the ink composition. Assessment of the print quality may include printing a bar code and assessing the grade of the bar code using a bar code verifier, measuring the thickness of a printed line or simply visually assessing the quality of printed text. A suitable bar code verifier that may be used for assessing the grade of a bar code is an Integra 9505 Barcode Quality Station. This equipment provides a bar code grading from A-F and ‘no valid code’ with A-C being an acceptable bar code and D, F and ‘no valid code’ being a low quality bar code.

To achieve high quality printing, or codes, it is preferable that wetting of the nozzle plate is minimized to prevent blocked nozzles, poor decap behaviour is minimized and/or changes in the drop trajectory are minimized. Preferably, an ink composition has a long decap time so that substantially perfect codes can be printed after periods of inactivity, and/or so that the quality of the printed image recovers quickly. Moreover, increased throw distance is desirable, for example, to enable printing onto curved surfaces where there is potential for a greater distance between the print head and the substrate. Typically current thermal inkjet printing systems have a throw distance of the order of 1 mm which limits the application of these systems to industrial marking and coding. It is therefore desirable to provide an inkjet ink composition, especially for use in thermal inkjet printing, which has a throw distance or greater than 1 mm, for example, of at least 2 mm, at least 3 mm, at least 5 mm or at least 10 mm.

Preferably the inkjet ink composition is used for drop-on demand printing, such as a thermal inkjet printing or piezo inkjet printing. Preferably, the inkjet ink composition as described herein is used for thermal inkjet printing.

Examples of suitable monosaccharides for use in the present invention include threose, erythrulose, erythrose, arabinose, ribulose, ribose, xylose, xylulose, lyxose, glucose, fructose, mannose, idose, sorbose, gulose, talose, tagatose, galactose, allose, psicose, altrose and mixtures of two or more thereof. Preferably the monosaccharide is selected from glucose and xylose and mixtures of two or more thereof.

Examples of suitable disaccharides include maltose, isomaltose, cellobiose, lactose, sucrose, trehalose, isotrehalose, gentiobioge, melibiose, turanose, sophorose, isosaccharose and mixtures of two or more thereof. Preferably the disaccharide is selected from maltose and isomaltose and mixtures of two or more thereof.

Examples of suitable Tri- or higher polysaccharides include homoglycans (such as glucan, fructan, mannan, xylan, galacturonane, mannuronane, and N-acetylglucosamine polymer); and heteroglycans (such as diheteroglycan and triheteroglycan) and mixtures of two or more thereof. Specific examples of such polysaccharides include maltotriose, isomaltotriose, panose, maltotetraose, maltopentaose and mixtures of two or more thereof. Preferably, the tri- or higher polysaccharides is selected from maltotriose, isomaltotriose and mixtures of two or more thereof.

Reducing branched oligosaccharides may be mentioned as disaccharides or tri- or higher polysaccharides. According to the present invention, the “reducing branched oligosaccharide” refers to an oligosaccharide which is constituted by about 2 to 10 monosaccharides, preferably 2 to 5 monosaccharides, has a branched structure, and a reducing capability. The oligosaccharide may be either a homo-oligosaccharide or a hetero-oligosaccharide with the homo-oligosaccharide being preferred.

According to a preferred embodiment of the present invention, the reducing branched oligosaccharide comprises at least two glucoses bonded to each other through an alpha-1,6 glucoside linkage and has a branched structure. This type of oligosaccharide is preferably prepared from one member or a mixture of two or more members selected from the group consisting of starch, amylopectin, and glycogen. The reducing branched oligosaccharide may be prepared from the above compound(s) by a commonly used conventional method. Among others, an example of preferred methods is hydrolysis. Further, according to the present invention, besides the hydrolysis of polysaccharides, glucoside linkage of glucose or isomerization of maltose may be used for the preparation of the reducing branched oligosaccharide.

The saccharide additive may comprise a reducing branched reducing oligosaccharide. The reducing branched oligosaccharide may be selected from the group consisting of isomaltose, panose, isomaltotriose and mixtures of two or more thereof.

Derivatives of saccharides include sugar alcohols, sugar acids, amino sugars, and thiosugars. Among them, sugar alcohols and amino sugars are preferred. Most preferably, the saccharide additive comprises or consists of one or more sugar alcohols.

The sugar alcohol may be a monosaccharide-derived sugar alcohols, a disaccharide-derived sugar alcohol, a tri-or higher polysaccharide-derived sugar alcohol and/or a mixture of two or more thereof.

Monosaccharides-derived sugar alcohols include glycerine, threitol, erythritol, arabitol, ribitol, xylitol, lyxitol, sorbitol (glucitol), mannitol, iditol, gulitol, talitol, galactitol, allitol, altritol and mixtures of two or more thereof. Preferably the monosaccharides-derived sugar alcohols comprises or is selected from the group consisting of glycerine, xylitol, sorbitol, mannitol and mixtures of two or more thereof. Preferably the saccharide derivative consists of one or more monosaccharides-derived sugar alcohols.

Disaccharides-derived sugar alcohols include maltitol, isomaltitol, lactitol, turanitol and mixtures of two or more thereof. Among them, maltitol and isomaltitol are preferred.

Suitable sugar acids include uronic acids (saccharide derivatives having a monocarboxylic acid) and aldaric acids (saccharide derivatives having a dicarboxylic acid). Specific examples of uronic acid include glyceric acid, threuronic acid, erythronic acid, xylilronic acid, ribulonic acid, arabinulonic acid, lyxulonic acid, mannuronic acid, glucuronic acid, gluronic acid, iduronic acid, talronic acid, altruronic acid, alronic acid, and galacturonic acid. Among them, glyceric acid is preferred. Specific examples of aldaric acids include glyceraric acid (tartronic acid), threaric acid (tartaric acid), erythraric acid (mesotartaric acid), xyraric acid, ribaric acid, arabaric acid, lyxaric acid, mannaric acid, glucaric acid, glaric acid, idaric acid, talaric acid, altraric acid, araric acid, and galactaric acid. Among them, glyceraric acid is preferred.

An amino sugar is a saccharide wherein at least one hydroxyl group of the sugar has been substituted by an amino group. A thio sugar is a saccharide wherein at least one of the oxygen atoms of the sugar has been substituted by a sulfur atom. An amino sugar may be prepared by substituting hydroxyl groups of sugar by an amino group, and a thio sugar may be prepared by substituting oxygen atoms of sugar by a sulfur atom.

As outlined above, the present inventors have surprisingly found that incorporating a saccharide additive into an ink composition provides an improved ink composition, for example one which has reduced nozzle plate wetting, increased throw distance and/or an increased decap time compared to prior art compositions. Surprisingly, the present inventors have found that one or more of these advantages is observed when only one or more monosaccharides and/or derivatives thereof are present in the inkjet ink composition, when only one or more disaccharides and/or derivatives thereof; and/or when only one or more of a tri- or polysaccharides and/or derivatives thereof are present in the inkjet ink composition.

Therefore, the present inventors have found that the saccharide additive may usefully consist of one or more monosaccharides and/or derivatives thereof. The saccharide additive may consist of one or more disaccharides and/or derivatives thereof. Alternatively, the saccharide additive may consist of one or more tri- or polysaccharides and/or derivatives thereof.

In one embodiment the inkjet ink composition as described herein comprises:
(a) a monosaccharide and/or derivative thereof; and/or
(b) a disaccharide and/or derivative thereof; but does not comprise
(c) a tri- or polysaccharide and/or derivative thereof.

In an alternative embodiment the inkjet ink composition as described herein comprises:
(a) a monosaccharide and/or derivative thereof; and/or
(c) a tri- or polysaccharide and/or derivative thereof;
but does not comprise
(b) a disaccharide and/or derivative thereof.

In an alternative embodiment the inkjet ink composition as described herein comprises:
(b) a disaccharide and/or derivative thereof; and/or
(c) a tri- or polysaccharide and/or derivative thereof;
but does not comprise
(a) a monosaccharide and/or derivative thereof.

It will be understood that more than one monosaccharide and/or derivative thereof may be present in composition. Additionally, or alternatively, more than one disaccharide and/or derivative thereof may be present in composition. Additionally, or alternatively, more than one a tri- or polysaccharide and/or derivative thereof may be present in composition.

In a preferred embodiment, the saccharide additive comprises or is selected from the group or consisting of one or more monosaccharide-derived sugar alcohols, one or more disaccharide-derived sugar alcohols and mixtures thereof.

The saccharide additive may be selected from the group consisting of a one or more monosaccharide-derived sugar alcohols, or one or more disaccharide-derived sugar alcohols.

Preferably, the saccharide additive comprises or is selected from the group consisting of glycerine, xylitol, sorbitol, mannitol, maltitol and mixtures of two or more thereof. More preferably, the saccharide additive comprises or is selected from the group consisting of glycerine, xylitol, sorbitol, mannitol, and maltitol. Inkjet ink compositions containing these saccharide additives have been found to have particularly improved properties, for example, reduced nozzle plate wetting, increased throw distance, and/or increasing decap time.

In one embodiment, when glycerine is present, it may be present in an amount of less than 10%, less than 5% or less than 2% by weight based on the total weight of the inkjet ink composition. In an alternative embodiment, the composition does not comprise glycerine.

Preferably, the inkjet ink composition comprises at least 0.01% by weight, at least 0.05% by weight, at least 0.5% by weight, at least 5%, at least 10% by weight of saccharide additive based on the total weight of the composition.

Preferably, the inkjet ink composition comprises at least 0.01% by weight, at least 0.05% by weight, at least 0.5% by weight, at least 5%, at least 10% by weight of a monosaccharide and/or derivative thereof based on the total weight of the composition.

Preferably, the inkjet ink composition comprises at least 0.01% by weight, at least 0.05% by weight, at least 0.5% by weight, at least 5%, at least 10% by weight of a disaccharide and/or derivative thereof based on the total weight of the composition.

Preferably, the inkjet ink composition comprises at least 0.01% by weight, at least 0.05% by weight, at least 0.5% by weight, at least 5%, at least 10% by weight of a tri- or polysaccharide and/or derivative thereof based on the total weight of the composition.

Preferably, the saccharide additive is present in the inkjet ink composition in an amount of from 0.05% to 15%, more preferably from 1.5% to 9.5%, more still preferably from 1.5% to 5% by weight based on the total weight of the composition. The saccharide additive may be present in an amount of from 3% to 10%, or from 5.5% to 9.5% by weight based on the total weight of the inkjet ink composition.

The present inventors have found that such levels of saccharide additive in the ink composition advantageously provide an ink composition having improved properties, for example, reduced nozzle plate wetting, increased throw distance, and/or increasing decap time.

Any suitable colourant may be used in the present invention. The colorant may comprise any suitable dye and/or pigment. The colorant refers to any species that may provide colour to the ink.

Suitable dyes include various dyes commonly used in ink compositions, especially used in inkjet methods, such as direct dyes, acid dyes, foodstuff dyes, basic dyes, reactive dyes, disperse dyes, vat dyes, soluble vat dyes, reactive disperse dyes and mixtures of two or more thereof.

Inorganic and organic pigments may be used as the pigment without particular limitation. Inorganic pigments usable herein include, in addition to titanium oxide and iron oxide, carbon blacks produced by known processes, such as contact, furnace, and thermal processes. Organic pigments usable herein include azo pigments (including azo lake, insoluble azo pigment, condensed azo pigment, and chelate azo pigment), polycyclic pigments (for example, phthalocyanine, perylene, perinone, anthraquinone, quinacridone, dioxazine, thioindigo, isoindolinone, and quinophthalone pigments), dye-type chelate pigment (for example, basic dye-type chelate pigments and acid dye-type chelate pigment), nitro pigments, nitroso pigments, and aniline black.

Carbon blacks usable for black inks include carbon blacks manufactured by Mitsubishi Chemical Corporation, for example, No. 2300, No. 900, MCF 88, No. 33, No. 40, No. 45, No. 52, MA 7, MA 8, MA 100, and No. 2200 B; carbon blacks manufactured by Columbian Carbon Co., Ltd., for example, Raven 5750, Raven 5250, Raven 5000, Raven 3500, Raven 1255, and Raven 700; carbon blacks manufactured by Cabot Corporation, for example, Regal 400 R, Regal 330 R, Regal 660 R, Mogul L, Monarch 700, Monarch 800, Monarch 880, Monarch 900, Monarch 1000, Monarch 1100, Monarch 1300, and Monarch 1400; and carbon blacks manufactured by Degussa, for example, Color Black FW 1, Color Black FW 2, Color Black FW 2 V, Color Black FW 18, Color Black FW 200, Color Black S 150, Color Black S 160, Color Black S 170, Printex 35, Printex U, Printex V, Printex 140 U, Special Black 6, Special Black 5, Special Black 4A, and Special Black 4.

Pigments for yellow inks include C.I. Pigment Yellow 1, C.I. Pigment Yellow 2, C.I. Pigment Yellow 3, C.I. Pigment Yellow 12, C.I. Pigment Yellow 13, C.I. Pigment Yellow 14, C.I. Pigment Yellow 16, C.I. Pigment Yellow 17, C.I. Pigment Yellow 73, C.I. Pigment Yellow 74, C.I. Pigment Yellow 75, C.I. Pigment Yellow 83, C.I. Pigment Yellow 93, C.I. Pigment Yellow 95, C.I. Pigment Yellow 97, C.I. Pigment yellow 98, C.I. Pigment Yellow 109, C.I. Pigment Yellow 110, C.I. Pigment Yellow 114, C.I. Pigment Yellow 128, C.I. Pigment Yellow 129, C.I. Pigment yellow 138, C.I. Pigment Yellow 150, C.I. Pigment Yellow 151, C.I. Pigment Yellow 154, C.I. Pigment Yellow 155, C.I. Pigment Yellow 180, and C.I. Pigment Yellow 185.

Pigments for magenta inks include C.I. Pigment Red 5, C.I. Pigment Red 7, C.I. Pigment Red 12, C.I. Pigment Red 48 (Ca), C.I. Pigment Red 48 8 (Mn), C.I. Pigment Red 57 (Ca), C.I. Pigment Red 57:1, C,I, pigment Red 112, C.I. Pigment Red 122, C.I. Pigment Red 123, C.I. Pigment Red 168, C.I. Pigment Red 184, and C.I. Pigment Red 202.

Pigments for cyan inks include C.I. Pigment Blue 1, C.I. Pigment Blue 2, C.I. Pigment Blue 3, C.I. Pigment Blue 15:3, C-I- Pigment Blue 15:34, C.I. Pigment Blue 16, C.I. Pigment Blue 22, C.I. Pigment Blue 60, C.I. Vat Blue 4, and C,I. Vat Blue 60.

Preferably, the dye is soluble in water at concentrations of at least 20 g/litre.

Preferably the colourant, (which may be a pigment or a dye) is present in an amount of from 0.1% to 15% by weight based on the total weight of the composition. More preferably, the inkjet ink composition comprises from 0.5% by 10% by weight of colorant based on the total weight of the composition.

Preferably, the mean particle diameter of the pigment is not more than 1 μm, more preferably not more than 500 nm. Laser diffraction methods may be used to measure the average particle size. Alternatively scanning electron microscopy may be used.

The carrier of the composition preferably comprises water and/or an organic solvent. Preferably the organic solvent is a water soluble organic solvent. As used herein the term “water soluble organic solvent” means a carbon based solvent that may be dissolved in water to create a solution. Preferably, the carrier comprises one or more solvents, preferably, organic solvents, which are miscible in water.

Examples of suitable water-soluble organic solvents include: alkyl alcohols containing 1 to 4 carbon atoms, such as ethanol, methanol, butanol, propanol, and isopropanol; glycol ethers, such as ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol mono-isopropyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-2-methoxybutanol, propylene glycol monomethyl ether, propylene glycol monoethyl ether, propylene glycol mono-t-butyl ether, propylene glycol mono-n-propyl ether, propylene glycol mono-isopropyl ether, propylene glycol mono-n-butyl ether, dipropylene glycol mono-n-butyl ether, dipropylene glycol monomethyl ether, dipropylene glycol monoethyl ether, dipropylene glycol mono-n-propyl ether, and dipropylene glycol mono-iso-propyl ether; and formamide, acetamide, dimethylsulfoxide, sorbitol, sorbitan, acetin, diacetin, triacetin, sulfolane, and mixtures of two or more thereof.

Preferably, the inkjet ink composition comprises ethanol, propanol, t-butyl alcohol, s-butyl alcohol and/or propylene glycol.

The inkjet ink composition may comprise a C₁ to C₄ alcohol, preferably ethanol. Preferably, the composition comprises at least 10% by weight of a C₁ to C₄ alcohol, preferably ethanol, based on the total weight of the ink composition.

Preferably, the carrier comprises or is selected from the group consisting of water, ethanol, isopropyl alcohol, (tert- or sec) butyl alcohol, propylene glycol or mixtures of two or more thereof. Most preferably, the carrier comprises or consists of water and ethanol. This is preferred because the ethanol allows faster drying of the printed code without having a detrimental impact on the throw distance of the ink composition.

Preferably the carrier comprises water.

Preferably, the inkjet ink composition comprises from at least 85% by weight, at least 90%, at least 95% by weight of carrier based on the total weight of the composition.

Preferably, the inkjet ink composition comprises less than 75% by weight, less than 70%, less than 65%, less than 60%, or less than 50% by weight of water based on the total weight of the composition.

Preferably, the inkjet ink composition comprises from 50 to 70%, or from 60 to 70%, or from 60 to 65% by weight of water based on the total weight of the composition.

Preferably, the inkjet ink composition comprises from 5 to 50% by weight, more preferably from 15 to 40% by weight water-soluble organic solvents (excluding water) based on the total weight of the composition. Advantageously, the solvents are chosen to ensure the correct balance between the ink drying time and the throw distance.

The inkjet ink composition may comprise one or more preservatives, humectants, surfactants, binders and mixtures of two or more thereof.

Suitable preservatives include sodium benzoate, benzoic acid, sorbic acid, potassium sorbate, calcium sorbate, calcium benzoate, methylparaben and mixtures of two or more thereof. The preferred preservative is sodium benzoate. The inkjet ink composition may comprise up to 2% by weight of preservative based on the total weight of the composition. More preferably, the inkjet ink composition comprises up to 1% by weight of preservative based on the total weight of the composition.

Suitable humectants include ethylene glycol, 1,3-propanediol, 1,4-butanediol, 1,4-cyclohexanedimethanol, 1,5-pentanediol, 1,6-hexanediol, 1,8-octanediol, 1,2-propanediol, 1,2-butanediol, 1,3-butanediol, 2,3-butanediol, diethylene glycol, triethylene glycol, tetraethylene glycol, polyethylene glycol, dipropylene glycol, polypropylene glycol, glycerol, 1,2,6-hexanetriol, sorbitol, 2-pyrrolidone, 2-propanediol, butyrolacetone, tetrahydrofurfuryl alcohol and 1,2,4-butanetriol and mixtures of two or more thereof. Preferably the humectant is selected from a group consisting of glycerol, tetrahydrofurfuryl alcohol, polypropylene glycol and mixtures of two or more thereof. The inkjet ink composition may comprise up to 30% by weight of humectants based on the total weight of the composition. More preferably, the inkjet composition comprises up to 20% by weight of humectants based on the total weight of the composition.

Suitable surfactants include anionic, cationic or non-ionic surfactants and mixtures of two or more thereof. Non-limiting examples of anionic surfactants include alkyl sulphate, alkylaryl sulfonate, dialkyl sulfonate, dialkyl sulphosuccinate, alkyl phosphate and polyoxyethylene alkyl ether sulphate. Non-limiting examples of cationic surfactants include alkylamine salt, ammonium salt, alkylpyridinium salt and alkylimidazolium salt. Non-limiting examples of non-ionic surfactants include polyoxyethylene alkyl ether, polyoxyethylene alkylaryl ether, sorbitan fatty acid ester, polyoxyethylene sorbitan fatty acid ester, polyoxyethylene sorbitol fatty acid ester, glycerine fatty acid ester, a fluorine-containing non-ionic surfactant and a silicon-containing non-ionic surfactant. Mixtures of two or more surfactants may be used. The inkjet ink composition may comprise up to 5% by weight of surfactant based on the total weight of the composition. More preferably, the inkjet ink composition comprises up to 1% by weight of surfactant based on the total weight of the composition.

Suitable binders include polyamide resins, polyurethane resins, rosin ester resins, acrylic resins, polyvinyl butyral resins, polyesters, phenolic resins, vinyl resins, polystyrene/polyacrylate copolymers, cellulose ethers, cellulose nitrate resins, polymaleic anhydrides, acetal polymers, polystyrene/polybutadiene copolymers, polystyrene/polymethacrylate copolymers, sulfonated polyesters, aldehyde resins, polyhydroxystyrene resins and polyketone resins and mixtures of two or more thereof. The inkjet ink composition may comprise up to 30% by weight of binders based on the total weight of the composition. More preferably, the inkjet ink composition comprises up to 10% by weight of binders based on the total weight of the composition.

Preferably the inkjet ink composition as described herein has a viscosity of about 0.5 to 6 mPa·s, more preferably from 1 to 4 mPa·s at 25° C. The viscosity of the composition may be measured using a viscometer such as a Brookfield DV-II+ vioscometer or a rheometer.

Preferably the inkjet ink composition as described herein has a surface tension of from 20 to 50 mN/m, more preferably from 25 to 40 mN/m at 25° C. The surface tension of the composition may be measured using equipment such as a du Noüy ring tensiometer or using the pendant drop method on a KSV Cam 200 optical tensiometer.

As outlined above, the present inventors have surprisingly found that a saccharide additive, wherein the saccharide additive comprises:
(a) a monosaccharide and/or derivative thereof; and/or
(b) a disaccharide and/or derivative thereof; and/or
(c) a tri- or polysaccharide and/or derivative thereof;
   may advantageously be used as a nozzle plate wetting reducing additive in an ink, preferably an inkjet ink, composition; and/or may advantageously be used as a throw distance increasing additive in an ink, preferably an inkjet ink, composition; and/or as a decap time increasing additive in an ink, preferably an inkjet ink, composition.

Preferably, the saccharide additive is present in the inkjet ink composition in an amount effective to reduce the nozzle plate wetting of an ink composition and/or to increase the throw distance of an ink composition, and/or to increase decap time of an ink composition. Preferably, the saccharide additive is soluble in the inkjet ink composition in the amount used. Preferably, the amount of saccharide additive present in the inkjet ink composition in an amount sufficient to reduce the nozzle plate wetting of an ink composition and/or to increase the throw distance of an ink composition, and/or to increase decap time of an ink composition without substantially negatively impacting other properties of the inkjet inks. The saccharide additive may be present in an amount ranging from approximately 0.05 wt % to approximately 15 wt %, or from 1 wt % to 10 wt %, or from 2 wt % to 5 wt % based on the total weight of the inkjet ink composition. Since the saccharide additive preferably does not negatively affect other properties of the inkjet inks composition, the saccharide additive may be used over a wide variety of ink carriers. In addition, more than one saccharide additive may be used in the inkjet ink composition to achieve the desired reduction in nozzle plate wetting and/or increase in the throw distance, and/or increase in the decap time of an ink composition.

Improvements in the quality of the inkjet ink composition upon addition of the saccharide derivative may, for example, be observed by a reduction in the nozzle plate wetting, for example, from complete flooding of the nozzle plate to virtually no wetting at all.

Improvements in the quality of the inkjet ink composition upon addition of the saccharide derivative may, for example, be observed by an increase of the decap time of the composition. Preferably, the inkjet ink composition has a decap time of greater than 30 minutes, greater than 45 minutes and more preferably greater than 60 minutes, for example in a thermal ink jet printer. Preferably addition of the saccharide derivative to an inkjet ink composition increases the decap time by at least 1 minute, by at least 2 minutes, by at least 5 minutes, more preferably by at least 10 minutes compared to the inkjet ink composition in the absence of the saccharide additive.

Improvements in the quality of the inkjet ink composition upon addition of the saccharide derivative may, for example, be observed in an increase of the throw distance of the composition. Preferably, addition of the saccharide additive to the inkjet ink composition increases the throw distance of the ink such that high quality codes (for example, preferably from A-C as defined above, more preferably A) can be printed with a gap of 5 mm between the printhead and the substrate. Additionally or alternatively, the loss of image quality when larger gaps of up to 10 mm are used is minimised through the use of the saccharide derivative.

The inkjet ink compositions are formulated by combining the components using methods known in the art. The saccharide additives described herein may be easily incorporated into existing formulation processes because the saccharide additive is present in the inkjet composition in a relatively low amount. Therefore, the saccharide additive preferably does not create solubility issues that require modifying existing formulation processes. Rather, the saccharide additive is simply added to the inkjet compositions along with other components of the inkjet compositions. Since the saccharide additives are easily incorporated into existing processes, the cost of reducing nozzle plate wetting and/or of increasing throw distance and/or of increasing decap time of an ink composition is low.

The present disclosure further provides a method for printing images on a substrate in a thermal ink jet printer comprising directing a stream of droplets of any of the embodiments of the thermal ink jet ink composition to a substrate and allowing the ink droplets to dry, thereby printing images on a substrate. Any suitable substrate may be printed in accordance with the invention. Examples of suitable substrates include porous substrates such as uncoated paper, semi-porous substrates such as aqueous coated paper, clay coated paper, silica coated paper, UV overcoated paper, polymer overcoated paper, and varnish overcoated paper, and non-porous substrates such as hard plastics, polymer films, polymer laminates, metals, metal foil laminates, glass, and ceramics. The paper substrates may be thin sheets of paper, rolls of paper, or cardboard. Plastics, laminates, metals, glass, and ceramic substrates may be in any suitable form such as in the form of bottles or containers, plates, rods, cylinders, etc.

Preferably, the inkjet ink composition as described herein is a food grade ink composition. Edible surfaces can be printed using the inks described herein. These foods include, without limitation, baked goods, biscuits and cakes, cookies, nuts, chocolates, cheeses, crackers and chips, and pastries, puddings and mousses, ice creams and creams, petfood and pet treats, main meal snacks, cereals, sausage casings and pharmaceutical tablets.

The inkjet ink composition of the present invention is of particular use for printing on egg shells. In the past providing high quality printing on egg shells has proved particularly difficult because of the curved shape of the egg and therefore the throw distance required is typically larger compared to printing on flat surfaces. Other difficulties encountered with providing high quality printing on egg shells include being able to provide an ink composition that has good water resistance, adhesion and contrast when printed onto the egg shell. Advantageously, using the compositions and methods described herein overcomes and/or mitigates at least some of the problems described above, providing an improved quality print.

In one embodiment of the present invention there is provided an ink cartridge comprising the ink composition as described herein.

In one embodiment of the present invention there is provided a substrate or article comprising a print produced by the method described herein.

In a preferred embodiment, the inkjet ink composition comprises from 1 to 70%, preferably from 50% to 70%, or from 60 to 65% by weight of water and from 1% to 15%, more preferably from 1.5% to 10%, or from 1.5% to 9.5%, or from 2 to 5% by weight of saccharide additive based on the total weight of the composition. Preferably, the saccharide additive comprises or is selected from the group consisting of glycerine, xylitol, sorbitol, mannitol, maltitol and mixtures of two or more thereof. Additionally and/or alternatively, preferably, the carrier comprises or is selected from the group consisting of water, ethanol, propanol, t-butyl alcohol, s-butyl alcohol, propylene glycol and mixtures of two or more thereof.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

The foregoing detailed description has been provided by way of explanation and illustration, and is not intended to limit the scope of the appended claims. Many variations in the presently preferred embodiments illustrated herein will be apparent to one of ordinary skill in the art, and remain within the scope of the appended claims and their equivalents.

These and other aspects of the invention will now be described with reference to the accompanying Figures, in which:

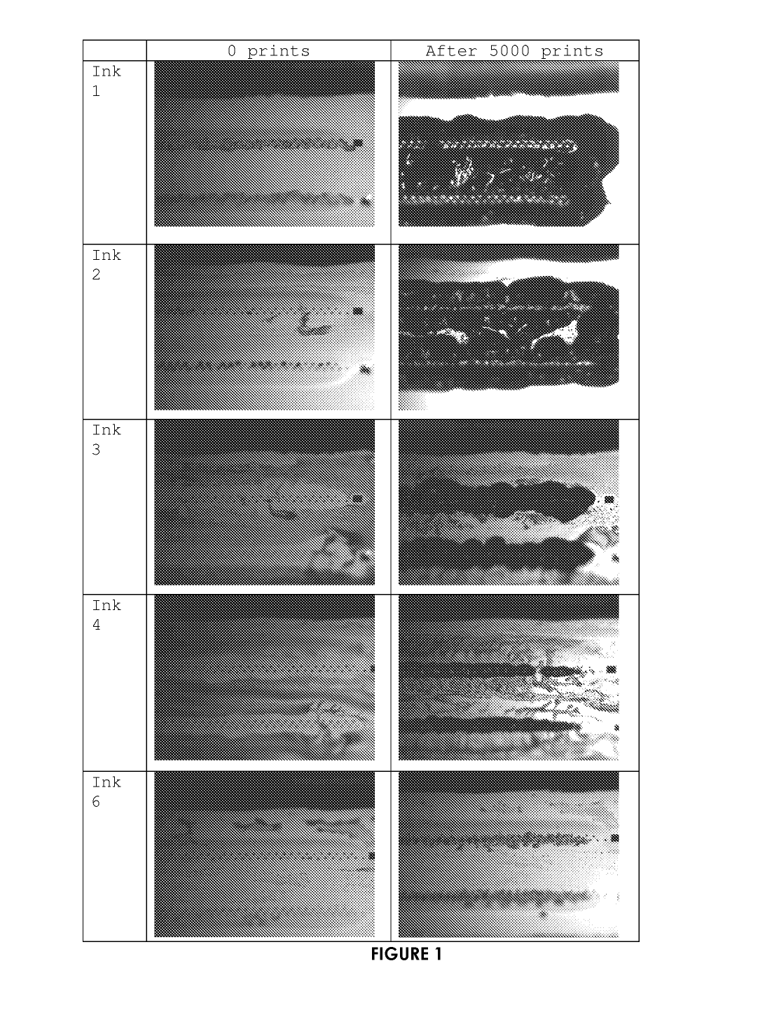

FIG. 1: shows the effect of sugar level on nozzle plate wetting when 1% humectant was included in the ink formulation.

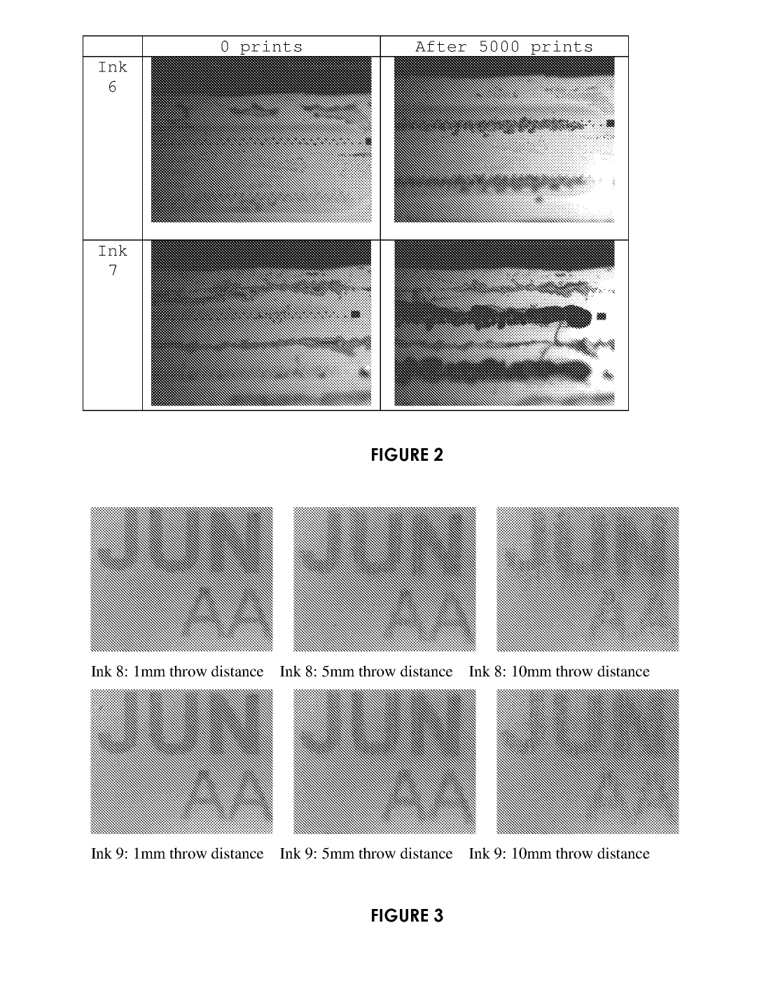

FIG. 2: shows the shows the degree of nozzle plate wetting achieved with two inks of similar viscosity.

FIG. 3: shows the effect on throw distance of adding a sugar to the ink formulation.

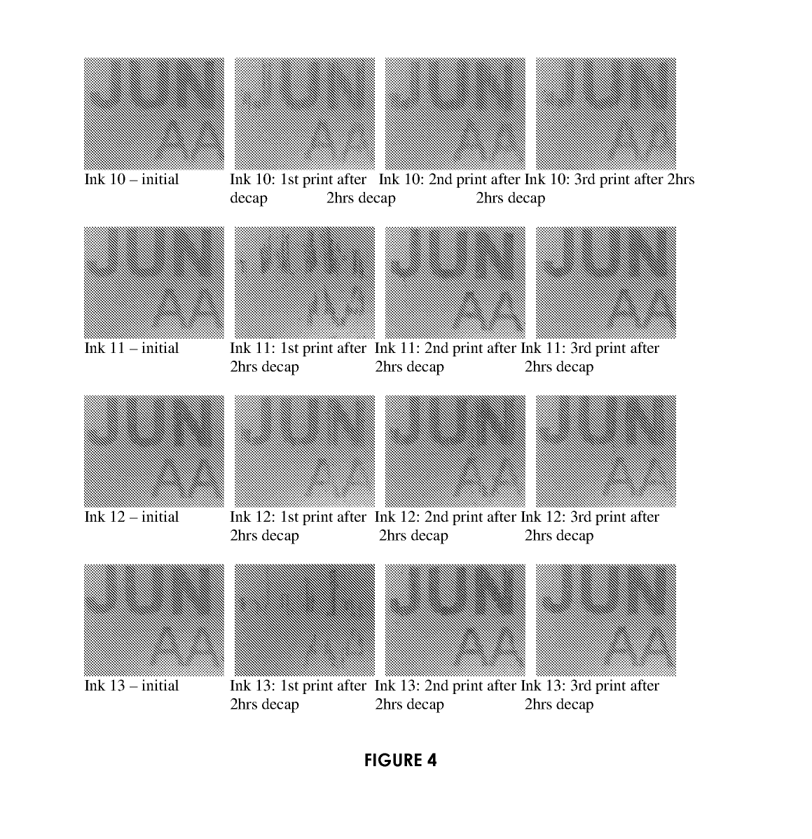

FIG. 4: shows the effect on decap performance of adding various sugars to the ink formulation.

FIG. 1 shows that as the level of sugar or sugar derivative in the formulation is increased, a significant reduction in nozzle plate wetting is achieved. Not surprisingly as the sugar/sugar derivative level is increased, the viscosity of the ink increases due to the higher % solids in the ink. However in FIG. 2, it will be seen that two inks of similar viscosity but different levels of sugar/sugar derivative have different levels of wetting, suggesting that this effect is not due to the increased viscosity of the ink. Indeed the small increase in viscosity seen would not be expected to have such a significant effect on nozzle plate wetting.

FIG. 3 shows that while inks with and without the sugar/sugar derivative give good image quality at 1 mm throw distance, as the distance between the nozzle and the substrate is increased, better image quality is achieved where the sugar is included in the formulation (ink 9).

FIG. 4 shows that the quality of the code printed with a control ink containing no sugar/sugar derivative (ink 10) is quite poor after the 2 hr time period and doesn't really recover with the 2nd and 3rd prints, indicating that the high print quality is unlikely to return. However when the various sugars were added to the formulations (inks 11-13), although the first code printed after the 2 hr period was generally poor, near to perfect image quality was achieved with the 2nd print.

The following non-limiting examples further illustrate the present invention.

### EXAMPLES

### Example 1

A set of Thermal inkjet inks suitable for printing directly onto the surface of food items were prepared using the formulations shown in Table 1 where the level of sugar, in this case Xylitol, was gradually increased from 0-5%.

TABLE 1

| | Ink 1 | | | | | |
|---|---|---|---|---|---|---|
| Component | (Control) | Ink 2 | Ink 3 | Ink 4 | Ink 5 | Ink 6 |
| Water/% | 67.9 | 66.9 | 65.9 | 64.9 | 63.9 | 62.9 |
| Ethanol/% | 30.0 | 30.0 | 30.0 | 30.0 | 30.0 | 30.0 |
| Xylitol/% | — | 1.0 | 2.0 | 3.0 | 4.0 | 5.0 |
| Preservative/% | 0.1 | 0.1 | 0.1 | 0.1 | 0.1 | 0.1 |
| Humectant/% | 1.0 | 1.0 | 1.0 | 1.0 | 1.0 | 1.0 |
| Dye/% | 1.0 | 1.0 | 1.0 | 1.0 | 1.0 | 1.0 |

Table 2 shows the viscosity when measured at 25° C. using a Brookfield DV-II+ viscometer at 60 rpm and the surface tension measured using the pendant drop method on a KSV Cam 200 optical tensiometer for each ink.

TABLE 2

| | | Surface Tension @ |
|---|---|---|
| | Viscosity @ 25° C. | 25° C. |
| Ink | (mPa · s) | (mN/m) |
| 1 | 2.45 | 33.41 |
| 2 | 2.46 | 33.63 |
| 3 | 2.53 | 33.26 |
| 4 | 2.59 | 33.41 |
| 5 | 2.67 | 32.44 |
| 6 | 2.74 | 32.42 |

To assess the effect of the sugar level on nozzle plate wetting, Lexmark cartridges were filled with each ink and a standard 6 line alphanumeric code was printed. Images of the nozzle plate were taken before printing commenced and after 500 prints.

FIG. 1 shows that with no sugar present in the formulation (ink 1), ink is seen to seep out of the nozzles even when not printing and after 5000 prints, significant nozzle wetting is seen. With 1% sugar in the ink (ink 2) poor nozzle plate wetting is still seen after 5000 prints, but as the level of sugar is increased, nozzle plate wetting is significantly decreased until at a sugar level of 5% (ink 6), virtually no nozzle plate wetting is seen.

The data in Table 2 indicate that this reduction in nozzle plate wetting is not related to the surface tension of the ink as very little change is seen across the range of inks. In fact if any comment can be made it is that the surface tension may decrease with increasing Xylitol levels, which would intuitively lead you to expect a higher degree of wetting and not the reduction in wetting that is observed.

As might be expected with increasing sugar level and therefore increasing solids content of the ink, the viscosity is seen to increase slightly with higher sugar levels. However this small increase in viscosity would not be expected to have such a significant effect on nozzle plate wetting.

To separate the effect of viscosity and sugar level a further ink sample was made (ink 7) where a higher level of humectant was used to increase the viscosity of the ink (see Table 3).

TABLE 3

| Component | Ink7 |
|---|---|
| Water/% | 62.9 |
| Ethanol/% | 30.0 |
| Xylitol/% | 1 |
| Preservative/% | 0.1 |
| Humectant/% | 5.0 |
| Dye/% | 1.0 |

Table 4 shows the viscosity when measured at 25° C. using a Brookfield DV-II+ viscometer at 60 rpm for ink 6 and 7.

TABLE 4

| | Viscosity @ 25° C. |
|---|---|
| Ink | (mPa · s) |
| 6 | 2.74 |
| 7 | 2.71 |

The data in Table 4 show that the viscosity of ink formulation 7 is similar to that of ink 6. However FIG. 2 shows that the nozzle plate wetting is considerably worse for ink 7 compared to ink 6, indicating that the effect on nozzle plate wetting is not as a result of increasing viscosity.

### Example 2

To investigate the effect on throw distance of the inclusion of a sugar in the ink formulation, a set of Thermal inkjet inks suitable for printing directly onto the surface of food items were prepared using the formulations shown in Table 5.

TABLE 5

| | Ink8 | |
|---|---|---|
| Component | (Control) | Ink 9 |
| Water/% | 68.9 | 63.9 |
| Ethanol/% | 30.0 | 30.0 |
| Xylitol/% | — | 5.0 |
| Preservative/% | 0.1 | 0.1 |
| Dye/% | 1.0 | 1.0 |

To assess the effect of including the sugar (in this case Xylitol) on throw distance, Lexmark cartridges were filled with each ink and a standard 6 line alphanumeric code was printed with increasing distances between the substrate (in this case paper) and the nozzles. Pictures were then captured of part of the printed code using a Celestron handheld digital microscope with 40× magnification.

The images in FIG. 3 show that while both inks give good image quality at 1 mm throw distance, as the distance between the nozzle and the substrate is increased, better image quality is achieved with ink 9 where the sugar is included in the formulation.

### Example 3

To investigate the effect on decap time of the inclusion of sugars in the ink formulation, a set of Thermal inkjet inks suitable for printing directly onto the surface of food items were prepared using the formulations shown in Table 6

TABLE 6

| | Ink10 | Ink | Ink | Ink |
|---|---|---|---|---|
| Component | (Control) | 11 | 12 | 13 |
| Water/% | 68.9 | 63.9 | 63.9 | 63.9 |
| Ethanol/% | 30.0 | 30.0 | 30.0 | 30.0 |
| Xylitol/% | — | 5.0 | — | — |
| Mannitol/% | — | — | 5.0 | — |
| Sorbitol/% | — | — | — | 5.0 |
| Preservative/% | 0.1 | 0.1 | 0.1 | 0.1 |
| Dye/% | 1.0 | 1.0 | 1.0 | 1.0 |

To assess the effect of including the sugars on the decap performance of the ink, Lexmark cartridges were filled with each ink and a standard 6 line alphanumeric code was printed. After 2 hrs with the cartridges left uncapped, the same 6 line code was printed again and the ease at which the quality of the printed codes recovered was examined. Pictures were captured of part of the printed code using a Celestron handheld digital microscope with 40× magnification.

The images in FIG. 4 show that the quality of the code printed with the control ink (ink 10) is quite poor after the 2 hr time period and doesn't really recover with the 2nd and 3rd prints, indicating that the high print quality is unlikely to return. When the various sugars were added to the formulations (inks 11-13), although the first code printed after the 2 hr period was generally poor, near to perfect image quality was achieved with the 2nd print.

While a specific embodiment has been described in detail above, it will be apparent to those skilled in the art that the disclosed embodiment may be modified using different ink formulations in alternative Thermal Inkjet printing heads. Experiments have shown that the performance of an ink in terms of nozzle plate wetting, throw distance and decap performance can be improved through the inclusion of one or more sugars to the formulation.

1. An inkjet ink composition comprising:
a colourant;
a carrier; and
a saccharide additive comprising:
(a) a monosaccharide and/or derivative thereof; and/or
(b) a disaccharide and/or derivative thereof; and/or
(c) a tri- or polysaccharide and/or derivative thereof.

2. The ink composition of claim 1, which is a thermal inkjet ink composition, preferably a food grade ink composition.

3. The ink composition of claim 1, wherein the derivative is a sugar alcohol, sugar acid, amino sugar or a thiosugar.

4. The ink composition of claim 3 wherein the saccharide additive is selected from the group consisting of one or more monosaccharides and/or derivatives thereof, preferably consisting of one or more monosaccharide-derived sugar alcohols.

5. The ink composition of claim 1, wherein the saccharide additive is selected from the group consisting of glycerine, xylitol, sorbitol, mannitol, maltitol and mixtures of two or more thereof.

6. The ink composition of claim 1, wherein the saccharide additive is present in an amount of from 0.05% to 15%, preferably from 1.5% to 9.5%, more preferably from 1.5% to 5% by weight based on the total weight of the composition.

7. The ink composition of claim 1, wherein the composition comprises less than 70%, less than 65%, preferably from 50 to 70%, or from 60 to 65%, by weight of water based on the total weight of the composition.

8. The ink composition of claim 1, wherein the carrier comprises water and/or an organic solvent, wherein the carrier is selected from the group consisting of water, ethanol, propanol, t-butyl alcohol, s-butyl alcohol, propylene glycol and mixtures of two or more thereof.

9. (canceled)

10. The ink composition of claim 1 further comprising a humectant, a preservative, a surfactant, and/or a binder, wherein the humectant is present in an amount of from 0.5% to 30% by weight based on the total weight of the composition.

11-26. (canceled)

27. A method of reducing the nozzle plate wetting of an ink composition, the method comprising adding a saccharide additive to said ink composition, wherein the saccharide additive comprises:
(a) a monosaccharide and/or derivative thereof; and/or
(b) a disaccharide and/or derivative thereof; and/or
(c) a tri- or polysaccharide and/or derivative thereof.

28. A method of increasing throw distance of an ink composition, the method comprising adding a saccharide additive to said ink composition, wherein the saccharide additive comprises:
(a) a monosaccharide and/or derivative thereof; and/or
(b) a disaccharide and/or derivative thereof; and/or
(c) a tri- or polysaccharide and/or derivative thereof.

29. A method of increasing decap time of an ink composition, the method comprising adding a saccharide additive to said ink composition, wherein the saccharide additive comprises:
(a) a monosaccharide and/or derivative thereof; and/or
(b) a disaccharide and/or derivative thereof, and/or
(c) a tri- or polysaccharide and/or derivative thereof.

30. The inkjet ink composition of claim 1, wherein the inkjet ink composition does not comprise a tri- or higher polysaccharide.

31. The method as defined in claim 27, wherein the inkjet ink composition does not comprise a tri- or higher polysaccharide.

32. The method as defined in claim 28, wherein the inkjet ink composition does not comprise a tri- or higher polysaccharide.

33. The method as defined in claim 29, wherein the inkjet ink composition does not comprise a tri- or higher polysaccharide.
